(19) United States
(12) Patent Application Publication
(10) Pub. No.: US 2004/0112132 A1
(43) Pub. Date: Jun. 17, 2004

(54) Rotational stabilization of disc drives dring servo track writing operations

(76) Inventors: Louis J. Fioravanti, Boulder, CO (US); Steve T. Sheeran, Longmont, CO (US); Ashok Lakshmanan, Longmont, CO (US)

Correspondence Address: Mitchell K. McCarthy, Seagate Technology LLC, 10321 West Reno, OKM270, Oklahoma City, OK, 73127-7140, US

(21) Appl. No.: 10/644,248

(22) Filed: Aug. 20, 2003

Related U.S. Application Data
(60) Provisional application No. 60/405,457, filed on Aug. 23, 2002.

(51) Int. Cl. G01M 1/00

(52) U.S. Cl. 73/472

(57) ABSTRACT

A data storage device stabilization mechanism for a servo track writing (STW) nest is disclosed. The stabilization mechanism comprising a baseplate, at least two fixed restraints on the baseplate adapted to receive and position a data storage device on the baseplate, and at least two clamps on the baseplate. The clamps are operable to move between a first position and a second position. In the first position the clamps engage a data storage device positioned on the baseplate by the fixed restraints and apply a restraining force on the data storage device in a direction perpendicular to the disc rotation axis to dampen rotational movement of the data storage device relative to the baseplate. In the second position, the clamps do not engage the data storage device positioned on the baseplate allowing a data storage device to be positioned or removed easily.

### RELATED APPLICATIONS

This application claims priority of U.S. provisional application Serial No. 60/405,457, filed Aug. 23, 2002.

### FIELD OF THE INVENTION

This application relates generally to data storage devices and more particularly to writing servo tracks onto data storage media.

### BACKGROUND OF THE INVENTION

Data storage media, such as data storage discs in disc drives, possess closely spaced data tracks that serve as the repository for the information and data. In the art, there are several means for ascertaining the position of these data tracks. One is the use of reference tracks, referred to as dedicated servo tracks. Another, more common, means is to intersperse servo sectors in each data track. Servo tracks and/or servo sectors provide reference information so that the read/write (R/W) heads can be positioned directly over the data tracks. As the location of the servo tracks and sectors defines the location of the data tracks, writing servo tracks or servo sectors must be done before any data can be written. In the art, it is common to refer to a track containing only servo information as a “servo track.” Thus, both dedicated servo tracks and data tracks containing only servo sectors (i.e., after the servo sectors have been written thereby defining a data track but before any data has been written on the data track) are called “servo tracks.” In addition, the process of writing servo information to data discs to define the location of data tracks is referred to as the “servo track writing process” regardless of whether the process writes true servo tracks or servo sectors on data tracks. For the balance of this discussion, the term “servo track” will be used in the more general sense to refer to both dedicated servo tracks and data tracks as yet containing only servo sectors.

It is imperative that the servo tracks be established in an efficient, coherent manner such that the resultant servo tracks approximate perfect circles. However, due to vibration and aerodynamic disturbances, these servo tracks are seldom perfect. The aerodynamic (windage) and vibration disturbances excite system resonances, resulting in an imperfect track path. Since this servo track is written only once, any spurious vibration or windage excitation that serves to excite R/W head and disc resonances results in an imperfect servo track that forever remains on the disc drive. These permanent imperfections in the servo tracks detract from drive performance since the R/W heads must attempt to follow this imperfect servo track. In addition, imperfections in the servo tracks will force the disc drive designers to spread the tracks farther apart, thereby reducing the total capacity of the disc drive.

The servo track writing process is executed during drive manufacture by a servo track writer (STW). The STW is an electromechanical device that receives a disc drive and records the servo tracks onto the discs within the disc drive. Because the STW retains a disc drive during the servo track writing process, STWs are often referred to as nests or STW nests. An STW nest typically includes a baseplate for holding a disc drive during the STW process, a carriage adapted to receive a disc drive and place it on and remove it from the baseplate, and various electronics controlling the STW process. The typical STW baseplate is very heavy, often milled from a single piece of stainless steel and, often, attached to a vibration dampening table or similar supporting device to prevent any external vibrations from being transmitted to the disc drive during the servo track writing process. The disc drive is held against the baseplate by the carriage. As the disc drive is positioned on the baseplate by the carriage, a fixed actuator “push” pin that extended from the baseplate penetrates the disc drive case or housing and physically engages the actuator assembly. The actuator pin is finely controlled and, thus, allows very precise position control over movement of the actuator assembly during the servo track writing.

Proper positioning of the disc drive as it is placed on the baseplate relative to the actuator push pin is necessary so that the actuator pin penetrates into the disc drive. The STW baseplate typically includes several features for ensuring proper positioning of the disc drive as it is placed on the baseplate by the carriage. The baseplate typically has a several fixed positioning restraints. Some of the restraints may each have a sloping portion that grossly positions or guides the disc drive as it is being placed onto the STW baseplate by the carriage. The baseplate may also be provided with a solenoid actuated bumper for rough centering of the disc drive with respect to the restraints. Another positioning apparatus often used is a conical pin adapted to engage a screw head in the base of the disc drive. The conical shape of the pin provides finer positioning as the carriage presses the disc drive onto the baseplate.

It should be noted here that the positioning described above occurs while the disc drive is retained in the carriage. For the final positioning to be successful, the disc drive must be allowed to have some movement relative to the baseplate. The movement can be of the disc drive relative to the carriage or of the carriage relative to the baseplate. Typically, such movement is between the carriage and the disc drive. This is because the carriage is already limited in the amount of force the carriage can apply to the disc drive's housing. The carriage cannot hold the disc drive too firmly without damaging the disc drive. Carriages typically retain a disc drive through the use of a plurality of spring-loaded contacts that contact various points on the external case of the disc drive. Carriages typically contact the disc drive on the top and bottom covers of the disc drive, allowing some movement of the drive in all directions including in a direction perpendicular to the axis of rotation of the drive's data discs. The carriage contacts are limited in the force that can be applied to the external case, particularly the top cover. Too much force can damage the housing or flex the printed circuit boards mounted to the underside of the disc drive.

Typically, the fixed restraints do not retain the disc drive snugly. This is due to several reasons. First, as the restraints are part of the baseplate, repeated positioning of disc drives that require significant force to insert the disc drive into snug restraints would cause the baseplate to wear out quickly. Second, because the carriage is designed to simply lower the drive onto the baseplate, the baseplate must be able to easily receive the drive while also ensuring that it is placed in the correct position. Exceedingly tight restraints will increase the chance that the drive will get hung up or jammed during placement or removal.

The typical STW baseplate described above, while well adapted to prevent external vibrations from being transmitted to a retained disc drive, still allows some movement of the disc drive within the STW nest. Thus, movement of disc drive due to internally generated forces occurs. During the servo track writing process, the discs in the disc drive must be rotated. Vibrations may be caused by the disc drive's internal spindle motor and may also be caused by the rotational movement of the discs. These vibrations are often rotational in nature. For example, the spinning up and spinning down of the discs applies a rotational force on the disc drive relative to the STW nest. In addition, the rotational movement of the discs can set up rotational resonances between the disc drive and STW nest. Similar to the way an imbalanced ceiling fan will precess about its base due to rotational resonances, a disc drive in an STW nest can also precess about a contact point, such as the conical pin, during the servo track writing process.

Oftentimes, but not always, this rotational movement occurs at the electromagnetic switching frequencies that are generated by the spindle motor controller. These are common rotational vibration frequencies because the motor torque is rotational in nature.

Until recently, the minor rotational movement caused by the operation of the disc drive was acceptable and tolerated during the servo track writing process. At that time, the issue of concern was isolating the disc drive and STW nest from external vibrations. However, because of the shrinking track pitch requirements of current high capacity disc drives, now the movement induced by the operating disc drive has become a limiting issue on the precision with which the servo tracks can written by a STW.

Accordingly there is a need for preventing rotational movement of the data storage device during the STW operation. The present invention provides a solution to this and other problems, and offers other advantages over the prior art.

### SUMMARY OF THE INVENTION

Against this backdrop the present invention has been developed. A data storage device stabilization mechanism for a servo track writing (STW) nest is disclosed. The stabilization mechanism has a baseplate, at least two fixed restraints on the baseplate adapted to receive and position a data storage device on the baseplate, and at least two clamps on the baseplate. The clamps are operable to move between a first position and a second position. In the first position the clamps engage a data storage device positioned on the baseplate by the fixed restraints and apply a restraining force on the data storage device in a direction perpendicular to the disc rotation axis to dampen rotational movement of the data storage device relative to the baseplate. In the second position, the clamps are disengaged from the data storage device positioned on the baseplate allowing a data storage device to be positioned or removed easily.

Embodiments of the present invention may also be thought of as a baseplate portion of a servo track writer nest for writing servo tracks on a data storage device comprising a fixed positioning member on the baseplate for positioning the data storage device in a preferred location and at least one clamp mechanism on the baseplate spaced from the fixed positioning member and adjacent the preferred location. The clamp mechanism may include a solenoid attached to the baseplate, a cam member operatively coupled to the solenoid and retained in a cam slot on the baseplate such that operation of the solenoid moves the cam member within the cam slot, the cam member having a driving face, and a clamp member adjacent to the cam member, the clamp member having a contact face, a pivot and a cam face in contact with the driving face of the cam member, the clamp member rotatably mounted to the baseplate via the pivot. In the embodiment, operation of the solenoid moves the cam member between a first position and a second position. When in the first position, the cam member forces the clamp member to rotate about the pivot causing the contact face to apply a biasing force against a data storage device positioned in the nest. When in the second position, the cam member allows the clamp member to pivot into a disengaged position.

An embodiment of the present invention may also be thought of as a servo track writing nest having a carriage for receiving a data storage device and placing the data storage device on a baseplate and a means mounted on the baseplate for preventing rotational movement of the data storage device relative to the baseplate. The means for preventing rotational movement may be a clamping means applying a force perpendicular to an axis of rotation of discs in the data storage device. The clamping means could be hydraulically or electrically driven. An example of one clamping means is a clamp having at least one cam operated clamp mounted on the baseplate. The cam operated clamp is movable between a first position of engaging the data storage device to apply force in a direction perpendicular to the disc axis and a second position wherein the clamp does not engage the data storage device. The means may include a first clamp and a second clamp. The first clamp is adapted to engage the data storage device and to apply force to a data storage device in a first direction perpendicular to the axis. The second clamp is spaced apart from the first clamp and is adapted to apply force to the data storage device in a second direction different from the first direction.

These and various other features as well as advantages which characterize the present invention will be apparent from a reading of the following detailed description and a review of the associated drawings.

### BRIEF DESCRIPTION OF THE DRAWINGS

FIG. 1 is a disc drive.

FIG. 2 shows a side view of a disc drive held in a carriage suspended above a baseplate in an STW nest.

FIG. 3 shows an exploded view of the baseplate of the STW nest in FIG. 2 in accordance with an embodiment of the present invention.

FIG. 4 shows a cross section of the baseplate in FIG. 3 having a disc drive positioned thereon and showing the clamp mechanisms engaging the disc drive to prevent rotational movement of the disc drive while in the STW nest.

FIG. 5 is a flow chart of a method of preventing rotational movement of a data storage device in a STW nest in accordance with an embodiment of the present invention.

### DETAILED DESCRIPTION

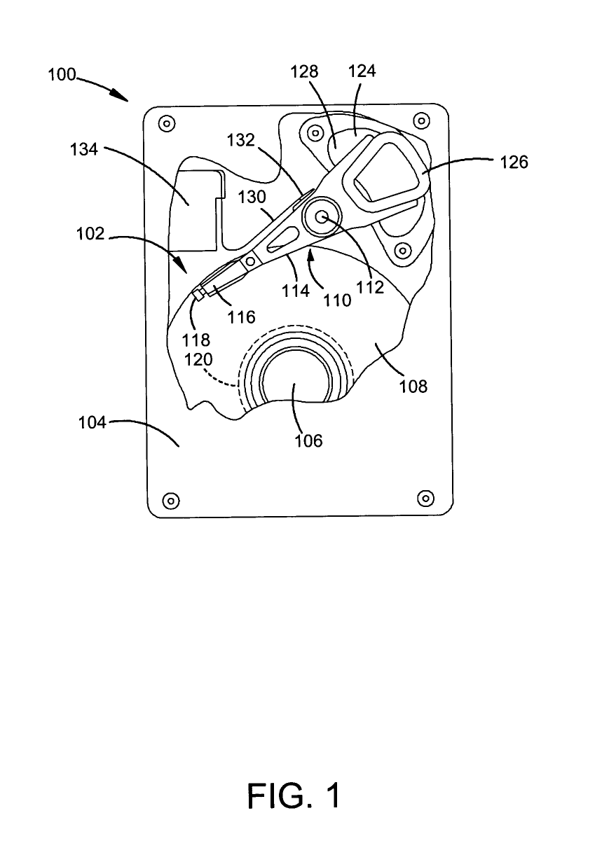

A disc drive 100 is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 that includes an fluid bearing slider enabling the head 118 to fly in close proximity above the corresponding surface of the associated disc 108 as a result of its movement through the fluid atmosphere within the disc drive 100.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

As discussed above, servo tracks are often written onto data storage discs by servo track writer (STW) nests. For the reasons discussed in the background, it is an imperative that the stabilization mechanism of the STW nest minimize the movement of the data storage device during the servo track writing process, as such movement will likely result in imprecise track writing, which negatively impacts the drive's performance. Until recently, manufacturers have focused on reducing external vibrations to the drive during the STW process. Embodiments of the present invention are stabilization mechanisms for STWs that prevent retained data storage devices from rotating while in the nest due to internal vibrations and resonances caused by the operation of the spindle motor during the STW process.

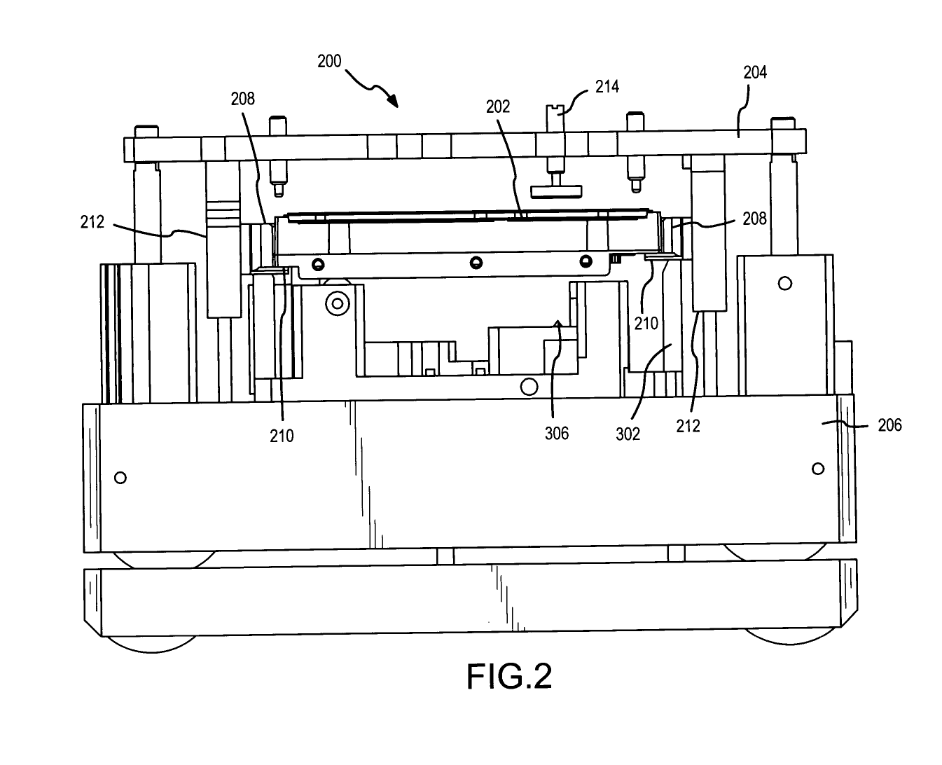

FIG. 2 shows an end view of an STW nest 200 with a disc drive 202 held in a carriage 204 suspended above a baseplate 206. FIG. 2 shows the carriage 204 in its drive receiving position with the disc drive 202 suspended above the baseplate 206. The carriage 204 includes two opposing rails 208 sized to hold the disc drive 202 therebetween. Each rail 208 includes a small platform member 210 that extends partially under the disc drive 202 and that supports the disc drive 202 when it is raised and lowered. When supported by the platform members 210, substantially all of the bottom surface of the disc drive 202 is exposed to the baseplate 206.

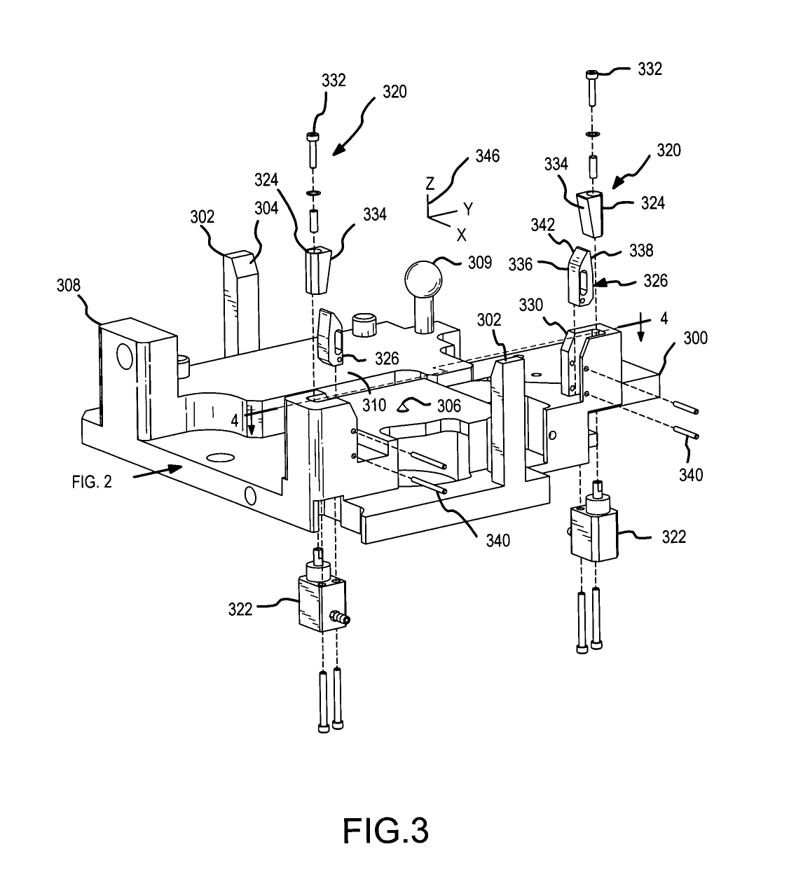

The rails 208 are attached to lifting mechanisms 212. In the embodiment shown, the lifting mechanisms 212 are solenoid activated plunger mechanisms that simultaneously move the rails 208 from the receiving position (shown) to a lowered position (not shown) wherein the disc drive is resting on the baseplate 206. As the disc drive 202 is lowered, the disc drive 202 is positioned first by fixed restraints 302 mounted on the baseplate 206 and then finely positioned by the conical pin 306. The positioning of the disc drive 202 by the fixed restraints 302 and conical pin 306 is discussed in greater detail in reference to FIG. 3. When in the lowered position, the rails 208 are no longer in contact with the disc drive 202 and the disc drive 202 is entirely supported by the baseplate 206. However, when in the lowered position the carriage 204 does contact the disc drive via one or more spring-loaded contacts 214 that lightly press (in one embodiment, approximately 20 pounds of total clamping force is used) the disc drive 202 onto the baseplate 206.

FIG. 3 is an exploded view of a baseplate 300 of the STW nest shown in FIG. 2 in accordance with an embodiment of the present invention. Proper positioning of the disc drive 301 as it is placed on the baseplate 300 relative to the actuator push pin (not shown) is necessary so that the actuator push pin penetrates into the disc drive 301. The STW baseplate 300 includes several features for ensuring proper positioning of the disc drive 301 as it is placed on the baseplate 300 by the carriage (not shown). As shown in FIG. 3, the baseplate 300 includes a plurality of fixed positioning restraints 302 spaced about the disc drive retention area 310 of the baseplate. Each of the restraints 302 in the embodiment are provided with a sloping portion 304 that grossly positions the disc drive 301 as it is being placed onto the STW baseplate 300 by the carriage. The baseplate 300 is also provided with a solenoid-actuated “crowder” cylinder (not shown), located in a cylinder housing 308 for rough centering of the disc drive within the restraints 302. The crowder cylinder extends from the cylinder housing 308 and clocks the drive against the tooling ball 309. Another positioning apparatus often used is a conical pin 306 adapted to engage a screw head in the base of the disc drive 301. The conical shape of the pin 306 provides finer positioning as the carriage presses the disc drive onto the baseplate 300.

After the drive 301 is positioned on the baseplate 300 two rotary clamp mechanisms 320 engage the positioned disc drive to apply a restraining force. In the embodiment shown, each clamp mechanism includes a solenoid 322, a cam member 324 and a rotary clamp member 326. The solenoid 322 is attached to the baseplate vertically beneath a cam slot 330 within which the cam member 324 is retained. The solenoid 322 operates to retract or extend a plunger 332 vertically. The solenoid is coupled to the cam member 324 via the plunger 332, which penetrates the cam member 324 and the baseplate 300. Thus, when the solenoid operates to vertically move the plunger 332, the cam member is also moved vertically up or down within the cam slot 330 with the plunger 332.

The cam member 324 is a tapered wedge retained in the cam slot 330. In the embodiment, the cam member tapered wedge has a driving face 334 on the wedge that contacts the clamp member 326. Vertical movement of the cam member 324 results in movement of the driving face 334 relative to the clamp member 326.

The clamp member 326 has a contact face 336, a cam face 338, a pivot 340 at one end of the clamp member and a distal end 342. The cam face 338 is in contact with the driving face 334 of the cam member 324. The clamp member 326 is rotatably mounted to the baseplate via the pivot 340. The clamp member 326 is adjacent to the cam member 324 and attached within the cam slot 330 via pivot 340. Rotation about the pivot 340 results in the distal end 342 of the clamp member extending from the cam slot 330.

The clamp member 326 can rotate about the pivot 340 between a first position (not shown) to a second, substantially vertical, position in which the clamp member 324 is substantially within the cam slot 330. In the second position, the clamp member will not engage a disc drive 301 positioned on the baseplate and allowing disc drives to be easily removed from or placed on the base plate. In the first position, the clamp member has rotated about the pivot to extend from the cam slot and engage a disc drive 301 positioned on the baseplate 300. When in the first position, the clamp member will apply a biasing force against a data storage device positioned in the nest.

As mentioned above, operation of the solenoid 322 causes the plunger 332 to extend or retract vertically, subsequently causing the cam member 324 to move vertically with the cam slot 330. The wedge of the cam member 324 is so shaped that vertical movement of the cam member 324 will either force the clamp member 326 out of the cam slot 330 into the first position or allow the clamp member 326 to retract into the cam slot 330 into the second position. In one embodiment, solenoid 332 is a spring return air cylinder resulting in a very low clamping force so as to not push the drive off it's alignment pivot 306. However due to the metal to metal contact between the drive and the clamp member 326, the clamp member 326 and the cam member 324 and the cam member 324 and the baseplate 300 (via contact with the wall of the cam slot 330), the clamping system has very high stiffness which is critical to eliminating rotational vibration.

The clamp member 326, when not in contact with force by the cam member 324, will fall by gravity back into the cam slot 330. The clamp member 326 also includes a sloping face so that, in the event the clamp member does not fall back into the cam slot 330 due to friction, the clamp member will be forced back into the cam slot upon the placement of drive onto the STW baseplate.

There are alternative embodiments to having the clamp member 326 fall back via gravity into the cam slot 330 that achieve the same function. The clamp member 326 may be provided with an internal spring mechanism (not shown) that provides a slight biasing force to return the clamp member 326 to the second, disengaged, position within the cam slot 330 when the clamp member 326 is not forced by the cam member's 324 wedge to pivot out of the cam slot 330. In another alternative, the clamp member 326 could be moveably attached to the cam member 324 via a tongue and groove mechanism, ensuring that the cam face of the clamp member 326 and the driving face of the cam member remain in contact regardless of the position of the cam member 324 within the cam slot 330. In yet another embodiment an external spring mechanism could be provided.

In the embodiment shown in FIG. 3, there are two clamp mechanisms 320 on either side of the disc drive position that oppose each other. Other embodiments are also possible including having one or more clamp mechanisms, each opposing a fixed restraint. Regardless of the position about the baseplate of the clamps, embodiments of the present invention apply a biasing force against a positioned disc drive in a direction that is perpendicular to the rotational axis of the discs in the disc drive. The rotating of the discs during the servo track writing process will create rotational vibration and potentially set up vibrational resonances causing the disc drive rotate and/or vibrate about the z-axis 346 within the nest.

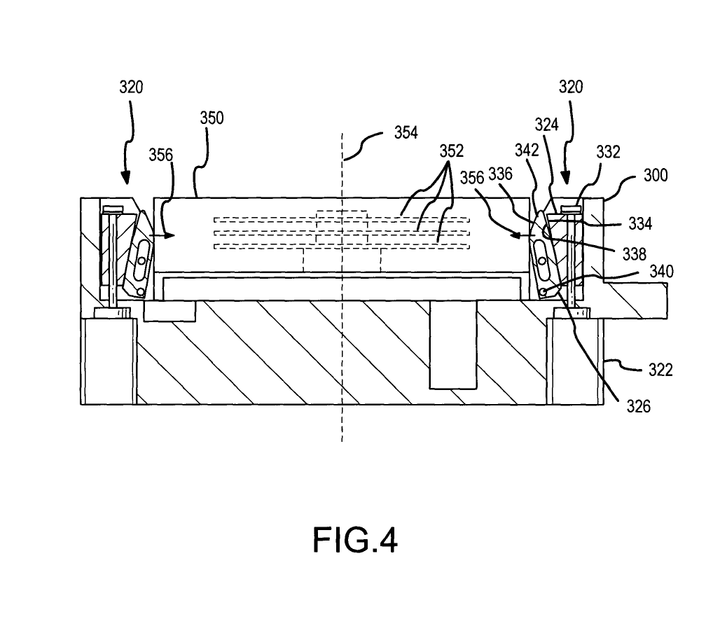

FIG. 4 shows a cross section view of a disc drive 350 positioned on the baseplate 300 of FIG. 3 with the clamp members in the first position, engaging the disc drive. The cross section is taken through the center of the two opposing clamp mechanisms 320 as shown on FIG. 3 by the section identifier 4. FIG. 4 shows the force 356 (symbolized by the arrows 356) applied to the disc drive 350 positioned on the baseplate 300. Also shown are the data storage discs 352 of the disc drive and the axis 354 of rotation of the discs 352.

The FIG. 4 shows that each clamp mechanism 320 is operable to apply force 356 in a direction perpendicular to the rotational axis 354 of the data storage discs. In the embodiment, the clamp mechanisms 320 are applying force in opposite directions as well as being located opposed to the other. Thus the clamp mechanisms prevent rotational movement of the disc drive relative to the baseplate during the servo track writing process. Note that this rotational stabilization must be instituted in such a way that it does not significantly displace the disc drive such that it no longer registers at the required datum points on the baseplate or within the nest. Without these rotational restraints, the disc drive is free to move rotationally in reaction to transient torque events that are generated by the electronics of the motor controller. External mechanical vibration and disc drive unbalance are examples of other sources of energy that can cause rotational movement.

Testing has been performed by writing servo tracks on disc drives with and without clamping to prevent rotational vibrations during the servo track writing process. Data indicates that the clamping reduced vibration significantly and increased the precision of the servo track writing.

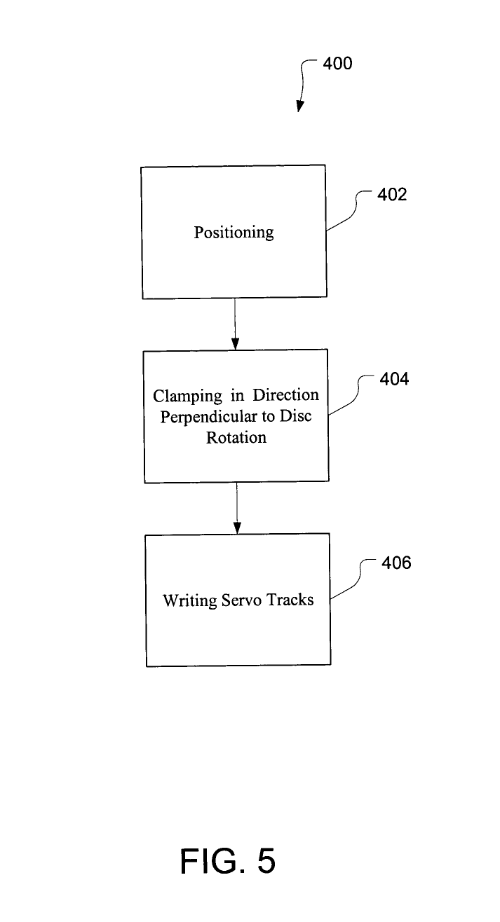

FIG. 5 presents an embodiment of a method 400 of preventing the rotational movement of a data storage device in accordance with the present invention. The method 400 begins with a positioning operation 402 that positions the data storage device within an STW nest. The position operation 402 may include receiving the data storage device in a carriage and placing the carriage on a baseplate of the STW nest. The positioning operation 402 may further include clocking the data storage device (via the crowder cylinder) and clamping in the axis parallel to the axis of rotation of the disc with the data storage device.

The positioning operation 402 is followed by a clamping operation 404 that applies a force to the data storage device in a direction perpendicular to the axis of rotation of discs in the data storage device. The clamping force prevents the data storage device from rotating within the STW nest. In alternative embodiments, multiple clamping operations 404 are performed, each applying a different clamping force in a direction perpendicular to the axis of rotation of the discs. The method 400 ends with a writing operation 406 wherein a plurality of servo tracks is written on one or more discs in the data storage device.

In summary, an embodiment of the present invention can be thought of as a data storage device stabilization mechanism for a servo track writing (STW) nest. The stabilization mechanism comprising a baseplate, at least two fixed restraints on the baseplate adapted to receive and position a data storage device on the baseplate, and at least two clamps on the baseplate. The clamps are operable to move between a first position and a second position. In the first position the clamps engage a data storage device positioned on the baseplate by the fixed restraints and apply a restraining force on the data storage device in a direction perpendicular to the disc rotation axis to dampen rotational movement of the data storage device relative to the baseplate. In the second position, the clamps do not engage the data storage device positioned on the baseplate allowing a data storage device to be positioned or removed easily.

In one embodiment, the clamps apply the restraining force against different sides of the data storage device. The clamps may include a solenoid-activated plunger coupled to a cam, the cam coupled to a clamp member, the solenoid operable to move the cam and thereby causing the clamp to move between the first position and the second position. The clamp member may include a solid dampener that contacts the data storage device when the clamp is in the first position or a means for dampening selected frequencies based on characteristics of the data storage device. The selected frequencies may include electromagnetic switching frequencies that are generated by a motor controller in the data storage device.

In one embodiment, the clamps are opposed and apply force in opposite directions. In another the clamps do not oppose each other. In yet another, an even number of clamps are provided, wherein each clamp is in opposition to another clamp such that each clamp exerts force in the direction of an opposing clamp. In yet another embodiment, each clamp is aligned in opposition to a fixed restraint.

Embodiments of the present invention may also be thought of as a baseplate portion of a servo track writer nest for writing servo tracks on a data storage device comprising a fixed positioning member on the baseplate for positioning the data storage device in a preferred location and at least one clamp mechanism on the baseplate spaced from the fixed positioning member and adjacent the preferred location. The clamp mechanism may include a solenoid attached to the baseplate, a cam member operatively coupled to the solenoid and retained in a cam slot on the baseplate such that operation of the solenoid moves the cam member within the cam slot, the cam member having a driving face, and a clamp member adjacent to the cam member, the clamp member having a contact face, a pivot and a cam face in contact with the driving face of the cam member, the clamp member rotatably mounted to the baseplate via the pivot. In the embodiment, operation of the solenoid moves the cam member between a first position and a second position. When in the first position, the cam member forces the clamp member to rotate about the pivot causing the contact face to apply a biasing force against a data storage device positioned in the nest. When in the second position, the cam member allows the clamp member to pivot into a disengaged position.

Embodiments of the present invention may also be thought of as a servo track writing nest comprising a carriage for receiving a data storage device and placing the data storage device on a baseplate and a means mounted on the baseplate for preventing rotational movement of the data storage device relative to the baseplate. The means for preventing the rotational movement may be a clamping means applying a force perpendicular to an axis of rotation of discs in the data storage device. The clamping means could be hydraulically or electrically driven. An example of one clamping means is a clamp comprising at least one cam operated clamp mounted on the baseplate. The cam operated clamp being movable between a first position of engaging the data storage device to apply force in a direction perpendicular to the disc axis and a second position wherein the clamp does not engage the data storage device. The means may include a first clamp and a second clamp. The first clamp is adapted to engage the data storage device and to apply force to a data storage device in a first direction perpendicular to the axis. The second clamp spaced from the first clamp and being adapted to apply force to the data storage device in a second direction different from the first direction.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For instance, embodiments of the present invention could be very different in structure while still preventing rotational movement of a disc drive relative to an STW nest. For example, a baseplate could be provided with multiple clamps in different locations and possibly having no fixed restraints or fixed positioning members at all. Numerous other changes may be made which will readily suggest themselves to those skilled in the art and which are encompassed in the spirit of the invention disclosed and as defined in the appended claims.

What is claimed is:

1. A data storage device stabilization mechanism for a servo track writing (STW) nest, wherein the data storage device includes data storage discs that rotate about an disc rotation axis, the stabilization mechanism comprising:
a baseplate;
at least two fixed restraints on the baseplate adapted to receive and position a data storage device on the baseplate; and
at least two clamps on the baseplate, the clamps operable to move between a first position, wherein the clamps engage a data storage device positioned on the baseplate by the fixed restraints and apply a restraining force on the data storage device in a direction perpendicular to the disc rotation axis to dampen rotational movement of the data storage device relative to the baseplate, and a second position, wherein the clamps do not engage the data storage device positioned on the baseplate.

2. The apparatus of claim 1, wherein the at least two clamps apply the restraining force against different sides of the data storage device.

3. The apparatus of claim 1, wherein the clamps each comprise:
a solenoid activated plunger coupled to a cam, the cam coupled to a clamp member, the solenoid operable to move the cam and thereby causing the clamp to move between the first position and the second position.

4. The apparatus of claim 3, wherein the clamp member includes a solid dampener that contacts the data storage device when the clamp is in the first position.

5. The apparatus of claim 1 further comprising:
a means for dampening selected frequencies based on characteristics of the data storage device.

6. The apparatus of claim 5, wherein the selected frequencies include electromagnetic switching frequencies that are generated by a motor controller in the data storage device.

7. The apparatus of claim 2, wherein the clamps are opposed and apply force in opposite directions.

8. The apparatus of claim 1, wherein each clamp is in opposition to another clamp such that each clamp exerts force in the direction of an opposing clamp.

9. The apparatus of claim 1, wherein each clamp is aligned in opposition to an opposed fixed restraint.

10. A method of writing servo tracks on a data storage disc in a data storage device, the data storage device having at least one data storage disc that rotates about a disc rotation axis, the method comprising:
positioning the data storage device in a servo track writer nest;
applying a first clamping force on the data storage device in a direction perpendicular to the disc rotation axis to prevent rotation of the data storage device relative to the servo track writer nest; and
writing a plurality of servo tracks on the at least one data storage disc.

11. The method of claim 10, wherein the positioning operation further comprises:
receiving the data storage device in a carriage; and
placing the carriage on a baseplate in the servo track writer nest.

12. The method of claim 10 further comprising:
applying a second clamping force on the data storage device in a different direction perpendicular to the disc rotation axis.

13. A baseplate portion of a servo track writer nest for writing servo tracks on a data storage device comprising:
at least one fixed positioning member on the baseplate for positioning the data storage device in a preferred location; and
and at least one clamp mechanism on the baseplate spaced from the at least one fixed positioning member and adjacent the preferred location, the clamp mechanism including:
a solenoid attached to the baseplate;
a cam member operatively coupled to the solenoid and retained in a cam slot on the baseplate such that operation of the solenoid moves the cam member within the cam slot, the cam member having a driving face;
a clamp member adjacent to the cam member, the clamp member having a contact face, a pivot and a cam face in contact with the driving face of the cam member, the clamp member rotatably mounted to the baseplate via the pivot; and
wherein operation of the solenoid moves the cam member between a first position and a second position, when in the first position the cam member forces the clamp member to rotate about the pivot causing the contact face to apply a biasing force against a data storage device positioned in the nest, when in the second position the cam member allows the clamp member to pivot into a disengaged position.

14. The baseplate portion of claim 13, wherein the data storage device includes at least one data storage disc that rotates about a disc axis and wherein the direction of the biasing force is perpendicular to the disc axis.

15. The baseplate portion of claim 13, wherein the at least one clamping mechanism comprises two clamping mechanisms.

16. The baseplate portion of claim 15, wherein the two clamping mechanisms apply biasing forces in opposing directions and are on opposite sides of the preferred location.

17. The baseplate portion of claim 13, wherein the clamping mechanism further comprises:
a spring member coupled to the clamp member, the spring member applying a force that returns the clamp member to the disengaged position when the cam in the second position.

18. A servo track writing nest comprising:
a carriage for receiving a data storage device and placing the data storage device on a baseplate; and
a means mounted on the baseplate for preventing rotational movement of the data storage device relative to the baseplate.

19. The servo track writing nest of claim 18, wherein the data storage device includes at least one data storage disc that rotates about a disc axis, and wherein the means for preventing the rotational movement comprises at least one cam operated clamp mounted on the baseplate, the cam operated clamp movable between a first position of engaging the data storage device to apply force in a direction perpendicular to the disc axis and a second position wherein the clamp does not engage the data storage device.

20. The servo track writing nest of claim 19, wherein the means for preventing the rotational movement comprises:
a first clamp adapted to engage the data storage device and to apply force to a data storage device in a first direction perpendicular to the axis; and
a second clamp spaced from the first clamp and adapted to apply force to the data storage device in a second direction different from the first direction.
